(19) United States
(12) Patent Application Publication
(10) Pub. No.: US 2013/0257123 A1
(43) Pub. Date: Oct. 3, 2013

(54) Shopping Trolley

(71) Applicant: WANZL METALLWARENFABRIK GMBH, Leipheim (DE)

(72) Inventors: Bernd Kraus, Haldenwang (DE); Daniela Seiter, Heilbronn (DE)

(73) Assignee: Wanzl Metallwarenfabrik GmbH, Leipheim (DE)

(21) Appl. No.: 13/850,373

(22) Filed: Mar. 26, 2013

(30) Foreign Application Priority Data
Mar. 26, 2012 (DE) DE102012102568.1

(51) Int. Cl. B62B 5/08

(52) U.S. Cl. CPC B62B 5/082
USPC 297/256.17

(57) ABSTRACT

The invention relates to a nestable trolley with a basket for holding goods, the rear side of which is formed by a flap (1) which is pivotable into the interior of the basket, the flap (1), for accommodating a child, having a supporting wall (2) having leg openings (6), and also a rear wall (3) and a seating plate (4), with further a cover (5) of changeable position being provided which hides the leg openings (6), so that an additional goods deposition area can be formed. The invention is distinguished in that the cover (5) is formed from a transparent material, or in that the cover (5) has openings (5.1).

The invention relates to a nestable trolley.

Nestable trolleys are known from the prior art. They have a basket for holding goods. The rear side of the basket is formed by a flap which is pivotable into the interior of the basket. The flap has a supporting wall provided with leg openings for accommodating a child, and furthermore a rear wall and a seating plate are provided.

A flap of this type is described for example in EP 1 562 816 B1. This represents a preferred embodiment of a flap.

The seating plate has what are called supporting fingers for securing to the rear wall, and the rear wall is provided with widened sections, so that the seating plate can be mounted on the rear wall in an improved manner.

Furthermore, a cover is known from the prior art, e.g., from EP 0 570 737 B1, which is arranged rotatably on the supporting wall and is constructed such that it can hide the leg openings of the supporting wall.

Now, it happens that flat goods are placed between the cover and the seating plate, but that the assistant at the checkout does not notice. This results in inventory discrepancies.

The object of the present invention is now to devise a nestable trolley in which the cover is altered accordingly, so that these inventory discrepancies can be overcome.

The invention achieves this object with the features in the main claim. Further advantageous embodiments are described in the dependent claims.

Goods between the cover and the seating plate can always be recognised through the transparent cover. Even with the variant in which the cover has openings, it is obvious to the checkout assistant if goods are located between the two components. This is possible if the flap is opened, i.e., it can be used as a child seat, but also when the flap is closed.

The checkout assistant saves on the laborious manual opening of the flap due to the improved cover.

The invention will be explained in greater detail with reference to an example of embodiment.

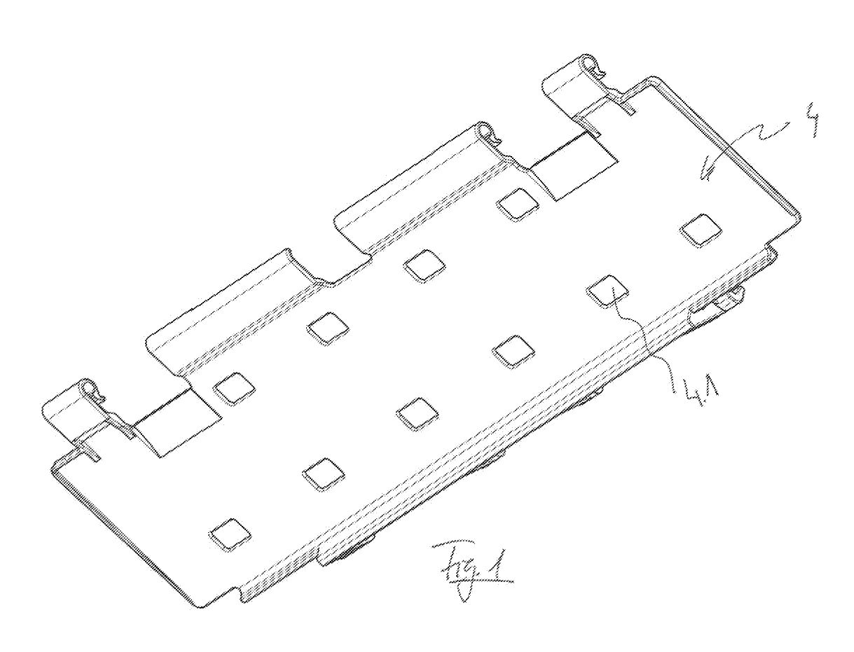

FIG. 1 shows a seating plate;

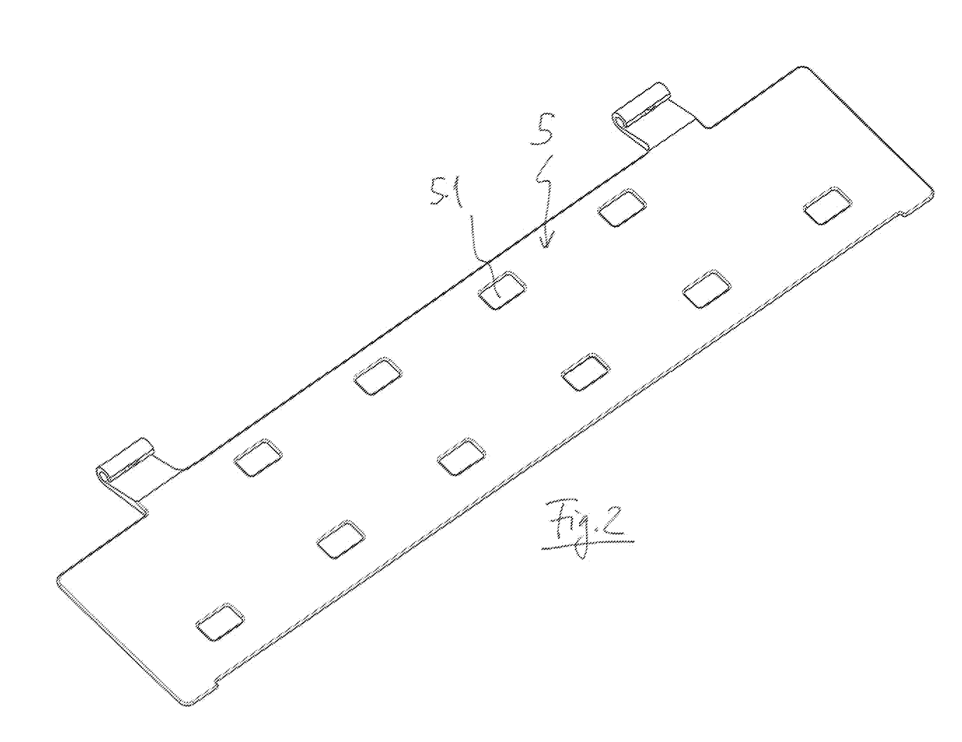

FIG. 2 shows a cover; and

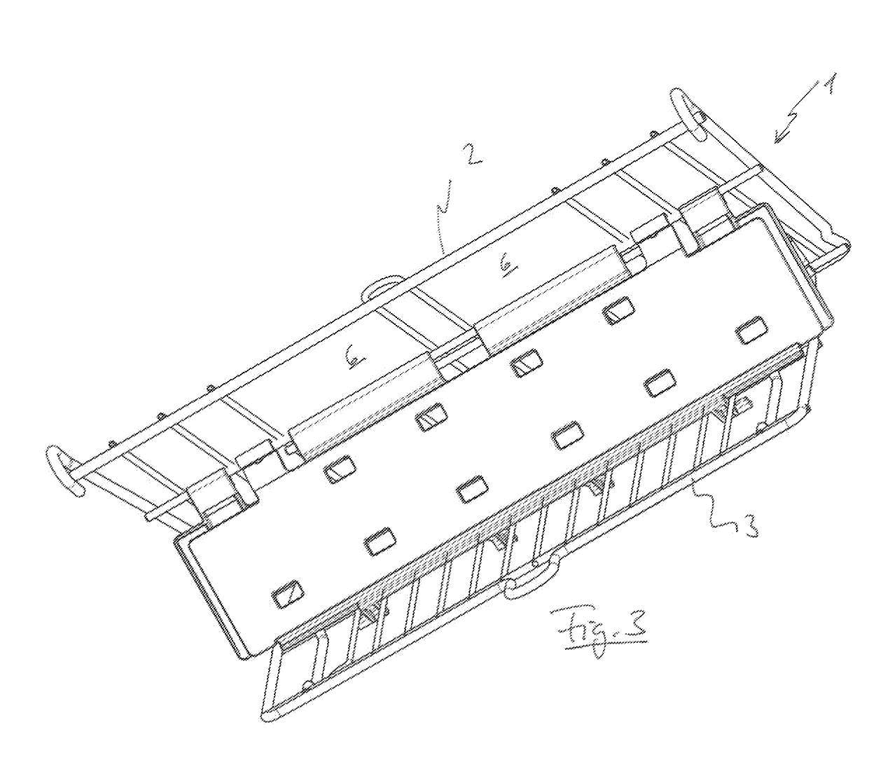

FIG. 3 shows a flap with a seating plate and cover.

The invention relates to a nestable trolley with a basket for holding goods. The rear side of the trolley forms a flap 1 which is pivotable into the interior of the basket.

The flap 1 has a supporting wall 2 and a rear wall 3. For accommodating a child, the supporting wall 2 is provided with leg openings 6 and a seating plate 4. A cover 5 of changeable position is attached which can hide the leg openings 6, so that an additional goods deposition area can be formed if the flap is not being used as a child seat.

The seating plate 4 and the cover 5 are mounted rotatably on the supporting wall 2. The seating plate 4 is furthermore also mounted on the rear wall 3. For simple mounting, it has proved useful to use a flap 1 as has already been described in EP 1 562 816 B1. A flap of this type has what is referred to as a widened section on the rear wall 3 for simple attachment of the seating plate 4. This widened section simplifies the introduction of the seating plate 4, which is equipped with supporting fingers. Furthermore, the upper side of the seating plate 4, if a plurality of trolleys are nested in one another, is directed towards the ground. Soiling of the upper side of the seating plate 4, e.g., due to weather, if the trolleys are positioned in the open, can thereby be very largely avoided.

The cover 5 lies on the seating plate 4, so that the flap 1 can be used as a seat for a small child. FIG. 3 shows this position of the flap 1. If the cover 5 is folded upwards and in the vertical position closes the leg openings 6 of the supporting wall 2, a new compartment is produced which can be used as an additional goods deposition area. For this, the seating plate 4 and cover 5 are formed from flat surfaces. It has proved useful for the cover 5 to be formed smaller in terms of its surface than the seating plate 4.

In order to prevent goods, such as flat objects, being placed between the seating plate 4 and the cover 5 and not being recognised by the checkout assistant at the checkout, the cover 5 is preferably formed from transparent material. In addition, the cover 5 formed from this transparent material may have openings 5.1.

Also, the cover 5 can be formed from the material of the seating plate 4, and hence from a non-transparent material. Then the cover 5 would have to be provided with openings 5.1.

Preferably the seating plate 4 and cover 5 are formed from a plastics material.

It has also proved useful for the seating plate 4 likewise to have openings 4.1. Thus the checkout assistant can check simply whether goods are located between the seating plate 4 and the cover 5, even if the flap 1 is closed.

The openings 4.1, 5.1 are preferably rectangular in form: a size of 12 to 20 mm has proved useful. This size furthermore rules out injury to the fingers of small children sitting on the child seat.

Square or round openings or alternatively slots would also be conceivable as openings 4.1, 5.1.

As can be seen from FIGS. 1 and 2, the number of openings 4.1, 5.1 is identical. Furthermore, it has proved useful for the openings 4,1 of the seating plate 4 and the openings 5.1 of the cover 5 to be made of the same size, and for the openings 4.1, 5.1 furthermore to be mounted one above the other in each case. This too permits simple checking by the checkout assistant.

An arrangement of the openings 4.1, 5.1 in two rows, with one row providing four, and a further row six, openings 4.1, 5.1, has proved advantageous. However, both a different number and a different arrangement are also conceivable.

### LIST OF REFERENCE NUMERALS

1 flap

2 supporting wall

3 rear wall

4 seating plate

4.1 seating plate opening

5 cover

5.1 cover opening

6 leg openings

1. A nestable trolley with a basket for holding goods comprising: a flap (1) forming the rear side of the basket; the flap (1) being pivotable into the interior of the basket; the flap (1), for accommodating a child, includes a supporting wall (2) having leg openings (6), a rear wall (3) and a seating plate (4): a cover (5) of changeable position attached to the supporting wall which hides the leg openings (6) so that an additional goods deposition area can be formed; the cover (5) is formed so as to permit recognition of goods which may be located between the seating plate (4) and cover (5).

2. A nestable trolley according to claim 1, wherein the cover (5) is formed from a transparent material.

3. A nestable trolley according to claim 1, wherein the cover (5) includes openings (5.1).

4. A nestable trolley according to claim 1, wherein the seating plate (4) has openings (4.1).

5. A nestable trolley according to claim 1, wherein the seating plate (4) and cove are rotatably mounted to the supporting wall (2).

6. A nestable trolley according to claim 1, wherein the seating plate (4) and cover (5) are formed from flat surfaces.

7. A nestable trolley according to claim 1, wherein the cover (5) is formed smaller than the seating plate (4).

8. A nestable trolley according to claim 3, wherein the openings (5.1) in the cover (5) are rectangular in form.

9. A nestable trolley according to claim 4 wherein the openings (4.1) in the seating plate (4) are in rectangular form.

10. A nestable trolley according to claim 8, wherein the openings (5.1) in the cover (5) have a size of 12 to 20 mm.

11. A nestable trolley according to claim 9, wherein the openings (4.1) in seating plate (4) have a size of 12 to 20 mm.

12. A nestable trolley according to claim 1, wherein the seating plate (4) and cover (5) are formed from a plastics material.

13. A nestable trolley according to claim 1, wherein the seating plate (4) includes openings (4.1) and the cover plate (5) includes openings (5.1): openings (4,1) in the seating plate (4) and openings (5.1) in the cover (5) are substantially the same size; and the openings (5.1) in cover (5) are mounted above the openings (4.1) in seating plate (4).
